(19) United States
(12) Patent Application Publication
(10) Pub. No.: US 2002/0187019 A1
(43) Pub. Date: Dec. 12, 2002

(54) Fastener with indicia and method of making same

(76) Inventors: Ronald G. Campbell, Butler, PA (US); Steve A. Macefe, Renfrew, PA (US)

Correspondence Address: R. Lewis Gable, Esq., Cowan, Liebowitz & Latman, P.C., 1133 Avenue of the Americas, New York, NY, 10036, US

(21) Appl. No.: 10/154,250

(22) Filed: May 23, 2002

Related U.S. Application Data
(60) Provisional application No. 60/297,554, filed on Jun. 12, 2001.

(51) Int. Cl. F16B 31/02

(52) U.S. Cl. 411/439; 411/13

(57) ABSTRACT

A method of indicating the gauge and length of a nail on the nail itself. Each nail is marked with a designated indicator preselected to indicate a specific gauge and shaft of a nail.

### FIELD OF THE INVENTION

This invention relates generally to nails, and more particularly to placing graphic indicators on the head of nails to visually identify the length and gauge of the nail.

### BACKGROUND OF THE INVENTION

Nails are used for various applications by both industrial and homebuilders. Since there are many various applications, there are an even greater number of nail sizes and or types of nails needed.

Although for some finished products, made from wood or by products, the nail size is chosen so as not to split the wood or not to have the point protrude. In industrial and home building construction, the diameter and length of the nail is important to provide a safe and durable structure. To assure these structures are built properly, modern building codes have been established specifying nail sizes to be used for certain structure configurations.

Once the structure has been assembled, a building inspector must determine whether it has been built according to the code. Since these codes vary, for similar types of structures, by location where they are built, the same nail size cannot be used in all cases. For example, a building located in high wind or earthquake areas require a stronger nail than needed in other areas.

To assure the correct nail has been used the building inspector must pull out some nails to check the gauge and length. This must be done since many nails may have the same head size but have a different gauge and length. Once the nail is driven into the wood, it is impossible to identify its gauge or length.

To eliminate this time consuming procedure, it is advantageous to have the exposed head surface marked in a specific way that indicates the nail gauge and length. By use of a corresponding chart, the mark can be identified and thus the gauge and length will be known without being removed.

Marking or coloring fasteners has been done previously for various reasons. Some of the reasons are to identify the manufacturer, coloring to match the finish on the wood, identifying material hardness and weather protective coating.

Attempts have also been made to identify size but they have certain defects. One such attempt is described in U.S. Pat. No. 6,095,739 issued to Stephen Albertson, wherein the nail heads are painted a series of specific colors or combination of colors. The problem with colors is that they are difficult to distinguish after they have been in the structure for a short time. Weather conditions and types of wood can affect the color and cause confusion as to whether the correct nail was used.

Another nail was described in U.S. Pat. No. 5,511,917 issued to Charles Dickson wherein the head was marked with a system that required the nail to be positioned precisely to identify the nail length otherwise. The length could be misinterpreted. Also, some of the markings had to be small and thus difficult to identify.

There exists a need to have a system to identify the gauge and length of a nail after the nail is driven flush that could be quickly recognized and will not deteriorate in time. Furthermore, the system must be efficient and cost effective to produce.

To form a nail, a set of grippers holds a wire during the time a punch or the like strikes one end thereof with sufficient force to expand the end outwardly and thereby forming a head. The grippers are then released and the wire is advanced a specified distance. The amount the wire advances determines the shaft length of the nail. The wire is then cut forming a point or the like which will be the end that is driven into a workpiece. After the wire is cut, the nail falls free and the process is repeated for the next nail.

### SUMMARY OF THE INVENTION

The present invention provides a system to identify the gauge and length of a nail after it has been driven flush into a work piece. A portion of the top surface of the nail head is permanently deformed with a preselected graphical indicator during the forming of the head. A chart is made showing all the graphical indicators selected and the corresponding nail gauge and length assigned to each indicator.

By visually identifying the graphical indicator on the nail head and finding the same indicator on the chart, the gauge and length of the nail can be accurately obtained. The time consuming method of pulling nails to check that codes or construction specifications are adhered to can be eliminated.

In one aspect of the present invention there is provided a nail comprising a preselected wire gauge, a preselected specific length shaft portion, a first end shaped to enter the work piece and a second end that is enlarged to form a head. During the forming of the head, a mark, such as an alphabetic letter or geometric figure, is disposed on the upper surface of the head.

In another aspect of the present invention, there is provided a method of marking the top surface of the head by having the head forming punch configuration to include the means to mark the head with a predetermined indicator. This method is most cost effective, since the marking is done at the same time that the head is formed, thus not requiring any additional handling or secondary operations to produce the identifying indicator.

In another aspect of the present invention, there is provided a preselected graphical indicator that corresponds to a specific nail gauge and shaft length. Each nail having the same shaft length and gauge will be marked with the same graphical indicator configuration.

In another aspect of the present invention, there is provided a chart or the like containing a combination of gauge and shaft lengths with a preselected graphical indicator assigned to each combination. By identifying the mark on a particular nail head the chart or the like can be used to determine the nail gauge and shaft length.

In another aspect of the present invention, there is provided a method to determine the gauge and shaft length of a nail that has been driven flush into a work piece with out pulling the nail out and measuring the size.

### BRIEF DESCRIPTION OF THE DRAWINGS

Various features and advantages will be more apparent after the following description in connection with the accompanying drawings wherein:

FIG. 1 is a side elevation view of an illustrative nail including a head, shaft and work piece-entering end in accordance with the teachings of this invention;

FIG. 2 is a Top plan view of the head illustrating one illustrative graphical indicator;

FIG. 3 is a partial side elevation illustrating the graphical indicator embossed on the upper surface of the nail head;

FIG. 4 is the same as FIG. 3 wherein the indicator is indented into the head;

FIG. 5 is similar as FIG. 2 wherein the indicator is illustrated as combination of a letter and a numerical digit;

FIG. 6 is similar to FIG. 2 wherein the indicator illustrates possible geometric figures;

FIG. 7 is a chart comprising a table indicating the relationship between the mark located on the nail head and the preselected nail gauge and length;

FIG. 8 is a chart similar to FIG. 7 illustrating the mark as an alphabetic letter;

FIG. 9A is a perspective, partial section of a head forming punch after the wire has been struck and the head is formed on the wire; and

FIG. 9B is a side elevation partial section of the end of the wire held by the grippers prior to being struck with the head forming punch.

### DETAILED DESCRIPTION OF THE PREFERRED EMBODIMENTS OF THIS INVENTION

Reference will be made in detail to the apparatus and method of this invention as illustrated in the accompanying drawings.

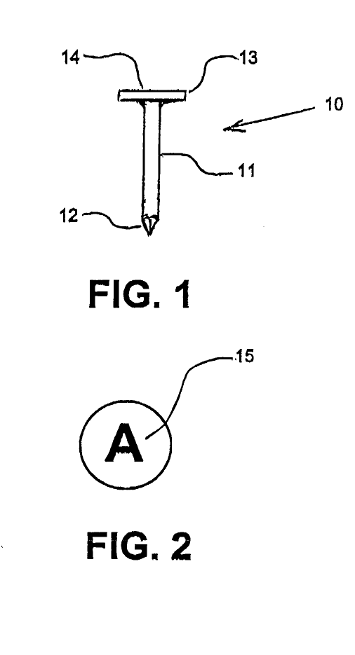

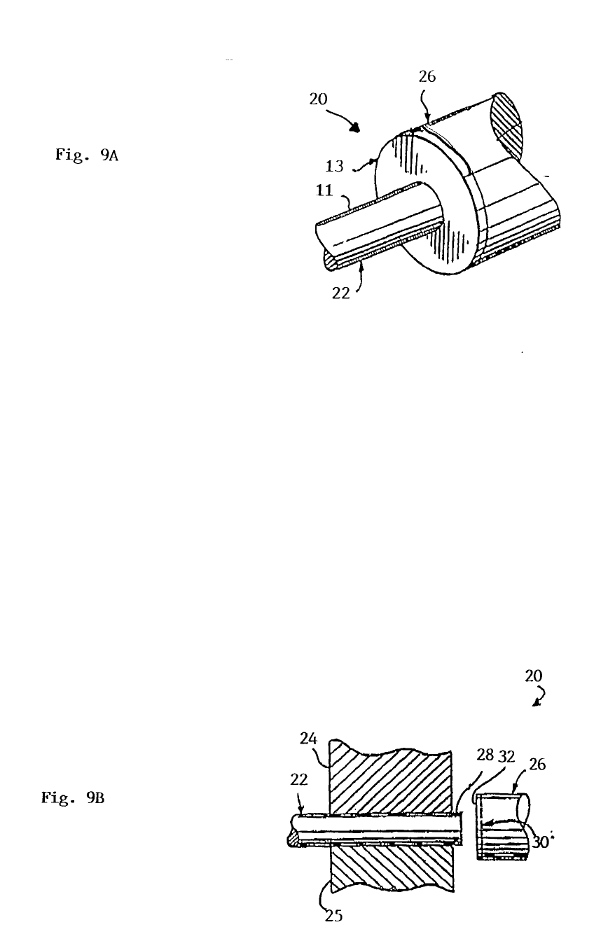

FIG. 1 shows a nail 10 comprising an elongated shaft 11, a material entering point 12 and a head 13. The head 13 is formed when the shaft 11 is struck by the ram portion or punch 26 of a nail forming machine 20 as shown in FIGS. 9A and 9B.

Nails have been made by various methods for many years. The apparatus 20 and method for making nails 10 is described with respect to FIGS. 9A and 9B as a version of that apparatus described in U.S. Pat. No. 5,533,379 (which is incorporated herein in its entirety by reference) that has been modified in accordance with the teachings of this invention. This patent further describes a method to control the size and shape of the nail head. In most nail making devices the head top surface is flat and, though the head is generally round, the size and shape can vary considerably. Illustratively, the nail 10 is manufactured by the apparatus 20, which is formed from a wire 22 by the head forming punch 26. To form the nail 10, the wire 22 is provided from stock of a pre-selected diameter and is typically captured between a pair of holding dies 24 and 25 with an end portion 28 of the wire 22 protruding therefrom (see FIG. 9B). The punch 26 is positioned adjacent to the end portion 28 so as to contact and axially compress the end portion 28 and thereby form the head 13 by forcing radially, outward expansion of the material of the wire 22. The punch 26 axially contacts the end portion 28 of the wire 22 with a predetermined force. In particular, the punch 26 axially compresses the end portion 28 and forces the radially, outward expansion of the end portion 28 of the wire 22 to form the head 13 as illustrated in FIG. 9A.

To provide the shaft 11 on the nail 10, the wire 22 is cut with a cutting tool (not illustrated) which is positioned on the side of the dies 24 and 25 opposite the punch 26. The cutting tool cuts and forms the point 12 (see FIG. 1) on the end of the now cut wire segment opposite the head 13 to complete the nail forming operation.

An embodiment of the invention is shown in FIG. 2, wherein a mark 15 is made on a surface 14 of the head 13 to identify certain physical characteristics of the nail 10, such as but not limited to the total length, the wire diameter used to produce the nail, the shaft shape, etc.

The head 13 and its top surface 14, are normally formed flat by the ram portion or punch 26 as shown in FIGS. 9A and 9B. In particular, the punch 26 has a surface 32, into which an indentation 30 (see FIG. 9B) configured in the form of the selected mark 15 is suitably formed. An embodiment of the invention is shown in FIG. 2, where the mark or indicia 15 is made on the surface 14 to identify certain physical characteristics of the nail 10, such as but not limited to total length, wire diameter used to produce the nail, shaft shape, etc.

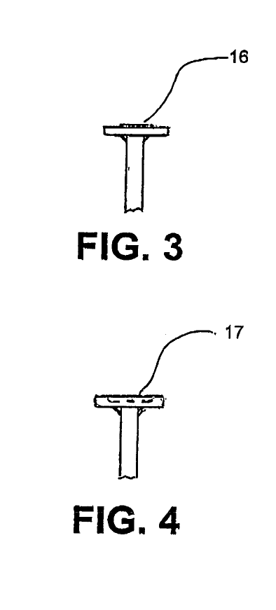

By locating the mark 15 on the surface 14, even after the nail 10 has been inserted into materials to be fastened, the physical characteristics can still be known without having to remove the nail. This aspect is important to allow inspection of finished products or buildings to see that the nails used meet construction codes that specify certain nail characteristics. Although the mark 15 can be done many different ways the preferred embodiment as shown in FIG. 3 is to have the mark 15 formed as an embossed portion 16 on the surface 14. This can be done without increasing the cost of production by having the mark 15 making feature as part of the punch 26, whereby the mark 15 is made at the same time the head 13 is formed.

The mark 15 could also be an indent 17 into the surface 14, as shown in FIG. 4, but should the head 13 thickness be thin, the mark 15 size might be limited to the size of the shaft 11 to prevent distortion of the head 13. The mark 15 could be a single numerical digit allowing for 10 different choices. If instead, an alphabet letter is used, the choice increases to 26.

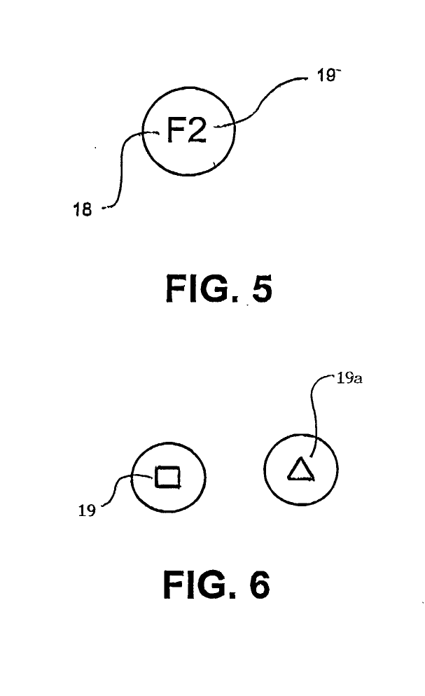

Referring now to FIG. 5, mark 15 comprises a combination of a letter 18 and a digit 19. By using the combination of the alphabet and a single numerical digit the choice increases to 260. FIG. 6 illustrates the use of geometric FIGS. 19, 19a. It becomes obvious by using more than one type of mark; the identification choice could become limitless.

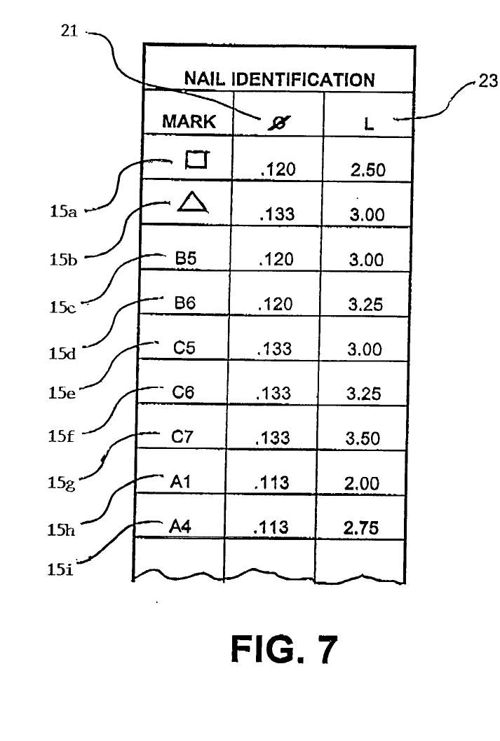

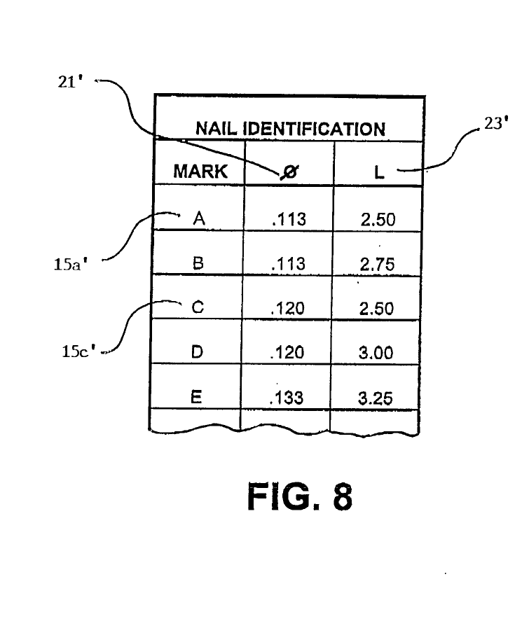

FIG. 7 and FIG. 8 show charts illustrating an illustrative example of an identification table defining two physical characteristics that are associated with specific marks 15.

Now referring to FIG. 7, the mark 15a, in the shape of a square, identifies a nail having a specific shaft diameter 21 and nail length 23. The mark 15b, in the shape of a triangle, identifies a nail having a different specific diameter and length. The mark 15c through 15i comprise a letter plus a digit. One identification system would utilize each letter to represent a specific diameter and the digit representing specific lengths. As shown in FIG. 7, all nails 10 having the same diameter would have the same alphabet letter. Likewise all nails 10 having the same length would have the same numerical digit. By illustrative example, the letters could start with the letter A representing 0.113 diameter, letter B represents 0.120, C represents 0.133 etc. The example for nail lengths could be 1 for 2.0 inch length, 2 for 2 ¼, 3 for 2 ½ inch, 4 for 2 ¾ inch, 5 for 3 inch, 6 for 3 ¼ inch, 7 for 3 ½ inch etc. The use of letters for diameter and digits for lengths could be reversed, whereby the letters would indicate lengths and digits indicating shaft diameters.

The preferred embodiment shown in FIG. 8 forms marks 15 as a single letter from the alphabet to identify the shaft diameter and the nail length. By using a single letter there can be 26 combinations of diameters and lengths. A single letter can also be made larger than using a combination since the nail head 13 is normally less than 5/16 diameter thus limiting the size of mark 15.

Most nailing applications do not require a specific nail size thus the need to identify the nail specifications after insertion is not needed. Therefore, every nail produced would not require a mark. In construction of houses or buildings, there has been certain codes established that do require specific nails to be used in attaching materials to form structures. A method to identify the correct nail was used for these applications without having to pull a few out for inspection.

As shown in FIG. 8, a table 33 utilizes a single letter 15′ used to identify the nail 10 having a specific diameter 21′ combined with a specific nail length 23′. By example, the letter A identifies the nail 10 having a shaft diameter 0.113 and a length of 2.5 inch. All nails having a 0.113 diameter and 2.5 length will have the mark A formed on the head 13. The third mark 15c′ identifies the nail 10 having the same length of 2.5 inch but the diameter is 0.120; therefore, this nail head 13 is marked with a different letter C. As shown, the letters B, D, and E identify nails having different combinations of diameters and lengths.

To be able to see the mark 15 clearly, a coating can be applied to the top surface of the head 13 that will enhance the visibility. The coating would not assist in nail characteristics identification and could be the same for all nails.

We claim:

1. A fastener comprising:
a shaft having a first end and a second end;
a material entering element coupled to said first end;
a head coupled to said second end, said head having a face; and
a pre-selected graphical indicator disposed on said face corresponding to the specific length and gauge of said fastener.

2. The fastener as defined in claim 1, wherein said graphical indicator comprises a single alphabetic letter.

3. The fastener as defined in claim 1, wherein said graphical indicator comprises a single geometric figure.

4. The fastener as defined in claim 1, wherein said graphical indicator comprises a combination of alphabetic, numeric and geometric figures.

5. The fastener as defined in claim 1, wherein said graphical indicator is embossed on said upper face.

6. The fastener as defined in claim 1, wherein said graphical indicator is indented into said upper surface.

7. A fastener comprising:
a shaft having a first and second ends;
a material entering element coupled to said first end;
a head coupled to said second end, said head having a face;
a pre-selected graphical indicator disposed on said face;
the graphical indicator to correspond to one of a plurality of indicators on a code table where each indicator indicates the specific length and gauge of said fastener.

8. The fastener as defined in claim 7, wherein said graphical indicator comprises an alphabetic letter.

9. The fastener as defined in claim 7, wherein said graphical indicator comprises a geometric figure.

10. A fastener as defined in claim 7, wherein said graphical indicator comprises a combination of alphabetic, numeric and geometric figures.

11. The fastener as defined in claim 7, wherein said graphical indicator is embossed on said face.

12. The fastener as defined in claim 7, wherein said graphical indicator is indented into said face.

13. A method of identifying the length and gauge of a fastener after the shaft of said fastener has been inserted into a material comprising;
providing a fastener having first and second ends, a head coupled to said second end, and an identifying graphical indicator disposed centrically on the exposed upper face of said fastener, the identifying indicator pre-selected to correspond to an indicator code indicating a specific length and gauge of said fastener,
inserting said shaft into a material so that said exposed upper face is visible, providing an indicator code table with a plurality of indicators where each said indicator corresponds to a different specific combined fastener length and gauge; and
correlating the indicator on said code table to the identifying said indicator on said exposed upper face of said fastener to determine the length and gauge of said fastener.

14. A method of manufacturing a fastener comprising the steps of:
advancing a continuous length of wire, the wire being of a predetermined gauge and having a leading end;
grasping the wire so as to expose the leading end of the wire;
forming the leading end of the wire into a head with a face; and
disposing on the face a graphic indicator corresponding to the gauge and a predetermined length of the nail.

15. The method of fastener manufacturing as claimed in claim 14, wherein there is comprised the further step of severing the length of wire to provide the fastener of the predetermined length.

16. The method of fastener manufacturing as claimed in claim 14, wherein there is comprised the further step of applying a punch along the axial length of the wire to form the head.

17. The method of fastener manufacturing as claimed in claim 16, the step of applying simultaneously disposing the graphic indicator to the face and forming the head.

18. The method of fastener manufacturing as claimed in claim 17, wherein the applying step embosses the graphic indicator into the face.
